(19) United States
(12) Patent Application Publication
(10) Pub. No.: US 2012/0250290 A1
(43) Pub. Date: Oct. 4, 2012

(54) LIGHT EMITTNG MODULE AND BACKLIGHT ASSEMBLY INCLUDING THE LIGHT EMITTING MODULE

(76) Inventors: Chan-Jae PARK, Busan (KR); Seung-Hwan Baek, Seoul (KR); Jae-Sang Lee, Chungcheongnam-do (KR); Young-Keun Lee, Chungcheongnam-do (KR); Young-Jun Seo, Seoul (KR); Young-Min Park, Seoul (KR)

(21) Appl. No.: 13/240,989

(22) Filed: Sep. 22, 2011

(30) Foreign Application Priority Data
Mar. 29, 2011 (KR) 2011-0028042

(51) Int. Cl. F21V 8/00; F21V 19/00

(52) U.S. Cl. 362/97.1; 362/382

(57) ABSTRACT

A light emitting module includes a light source, a printed circuit board, and a connector part. The printed circuit board includes a wiring layer having a wiring electrically connected to the light source, a heat dissipation layer formed under the wiring layer, and a through hole passing through the wiring layer and the heat dissipation layer. The connector part is disposed in the through hole and is electrically connected to the wiring for transmitting a power through the wiring to the light source. The heat dissipation layer may effectively dissipate the heat generated from the light source. A height of a protrusion of the connector part protruding from an upper surface of the printed circuit board may be minimized, such that a dark area caused by the connector part may be minimized, and display quality of a display apparatus including the light emitting module may be optimized.

### CROSS-REFERENCE TO RELATED APPLICATIONS

This application claims priority under 35 U.S.C. §119 to Korean Patent Application No. 2011-28042, filed on Mar. 29, 2011 in the Korean Intellectual Property Office (KIPO), the contents of which are herein incorporated by reference in their entirety.

### BACKGROUND OF THE INVENTION

1. Field of the Invention

Example embodiments of the present invention relate to a light emitting module and/or a backlight assembly including the light emitting module. More particularly, embodiments of the present invention relate to a light emitting module employed in a display apparatus and/or a backlight assembly including the light emitting module.

2. Description of the Related Art

Recently, a light emitting diode (LED) is generally employed as a light source of a display apparatus such as one of a liquid crystal display apparatus, an electrophoretic display apparatus, micro electro mechanical system (MEMS) display apparatus, etc. The LED is mounted on a printed circuit board, and the LED receives, through a connector equipped with the printed circuit board, power having different polarities to emit light.

If the connector is mounted on a front surface of the printed circuit board, a dark area is caused by the connector. As a result, the light efficiency associated with the display apparatus is decreased, and the display quality associated with the display apparatus is degraded. Thus, the connector may be preferably mounted on a rear surface of the printed circuit board.

If the connector is mounted on a rear surface of a FR4 printed circuit board, the connector mounted on the rear surface of the FR4 printed circuit board may be electrically connected to wirings formed on a front surface of the FR4 printed circuit board through a via. Typically, the FR4 printed circuit board may not efficiently dissipate heat generated from the light source; therefore, a metal core printed circuit board may be employed in place of the FR4 printed circuit board. The light source may be mounted on the metal core printed circuit board, which may include a heat dissipation layer made of a conductive material (such as aluminum) disposed on a rear surface of the metal core printed circuit board.

However, if the connector is mounted on the rear surface of the metal core printed circuit board on which the heat dissipation layer is disposed, an electrical short circuit may be generated by the heat dissipation layer and a receiving container that is coupled with the connector. The electrical short circuit may be a problem that makes the arrangement of mounting the connector may on the rear surface of the metal core printed circuit board undesirable.

### SUMMARY OF THE INVENTION

One or more embodiments of the present invention are related to a light emitting module capable of quickly dissipating heat generated from a light source and capable of minimizing a dark area caused by a connector.

One or more embodiments of the present invention are related to a backlight assembly having the above-mentioned light emitting module.

One or more embodiment of the present invention are related to a light emitting module that includes a light source, a printed circuit board (such as a metal core printed circuit board), and a connector part. The (metal core) printed circuit board includes a wiring layer having a wiring electrically connected to the light source, a heat dissipation layer formed under the wiring layer, and a through hole passing through the wiring layer and the heat dissipation layer. The connector part is disposed in the through hole and electrically connected to the wiring for transmitting a power through the wiring to the light source for driving the light source.

In one or more embodiments, the connector part may include a first connector and a second connector. The first connector may be inserted into (and/or disposed in) the through hole toward an upper surface of the wiring layer to be fixed to the metal core printed circuit board, and may be electrically connected to the wiring layer. The second connector may be inserted into and/or fixed to the first connector, may be electrically connected to the first connector, and may receive the power from an outside.

In one or more embodiments, the first connector may include a conduction part and a first housing. The conduction part may be electrically connected to the wiring. The first housing may receive and/or carry the conduction part and expose a first terminal of the conduction part. The second connector may be disposed inside the first housing

In one or embodiments, the second connector may include a wire, a terminal part, and a second housing. The wire may receive the power. The terminal part may electrically connect the wire and the conduction part. The second housing may receive and/or carry the terminal part, and may expose a first terminal of the terminal part contacting with a second terminal of the conduction part.

In one or more embodiments, the second connector may include a wire, a receptacle and, a second housing. The wire may receive the power. The receptacle may electrically connect the wire and the conduction part. The second housing may receive the receptacle such that the receptacle is disposed inside the second housing.

In one or more embodiments, an opening hole may be formed at the second housing and the conduction part may be inserted into and/or disposed through the opening hole.

In one or more embodiments, the receptacle may include a first fixing part, a second fixing part, and a connection part. The first fixing part may receive, fix, and/or securing the wire. The second fixing part may receive, fix, and/or securing the conduction part. The connection part may electrically connect the first fixing part and the second fixing part.

In one or more embodiments, the first connector may further include an adhesive part adhered to the (metal core) printed circuit board.

In one or more embodiments, the conduction part may protrude beyond a first side surface of the first housing, the adhesive part may be formed at a second side surface of the first housing and a third side surface of the first housing, and the second side surface of the first housing and the third side surface of the first housing may be adjacent to the first side surface of the first housing. In other words, the adhesive part may be formed at both side surfaces of the first housing adjacent to a first side surface of the first housing exposing the conduction part.

In one or more embodiments, the adhesive part may be further formed at a fourth side surface of the first housing opposite to the first side surface of the first housing.

In one or more embodiments, the adhesive part may be formed at four corners of the first housing.

In one or more embodiments, the first connector may include a groove receiving the second connector.

In one or more embodiments, the first connector may include a conduction part electrically connected to the wiring, the conduction part may be disposed at a first side of the first connector, the groove may include a first opening for receiving the second connector, the first opening may be disposed at a second side of the first connector, and the second side of the first connector may be perpendicular to the first side of the first connector. In one or more embodiments, the connector part may further comprise a third connector, the groove may further include a second opening for receiving the third connector, the second opening may be disposed at a third side of the first connector, and the third side of the first connector may be opposite to the second side of the first connector.

In one or more embodiments, the second connector may be inserted into and/or disposed at the groove in a first direction perpendicular to a second direction which the wiring layer and the heat dissipation layer are laminated along. In one or more embodiments, the second connector may be inserted into and/or disposed in the groove respectively through a first side surface and a second side surface opposite to the first side surface in the first direction.

In one or more embodiments, the first connector may include a conduction part electrically connected to the wiring, the conduction part may be disposed at a first side of the first connector, the groove may include an opening for receiving the second connector, the opening may be disposed at a second side of the first connector, and the second side of the first connector may be opposite to the first side of the first connector. In one or more embodiments, the second connector may be inserted into the groove in a second direction which the wiring layer and the heat dissipation layer are laminated along.

In one or more embodiments, the through hole may be formed at an edge portion of the printed circuit board, the connector part may include a conduction part electrically connected to the wiring, the conduction part may be disposed at a first side of the connector part, a second side of the connector part may be perpendicular to the first side of the connector part, and the second side of the connector part may be exposed from the printed circuit board at the edge of the printed circuit board. In one or more embodiments, the through hole may be formed at an outer portion of the (metal core) printed circuit board, and a portion of the connector part may be exposed and visible from outside of the (metal core) printed circuit board.

In one or more embodiments, the through hole may be formed at an inner portion of the (metal core) printed circuit board, and the connector part may be surrounded by an outer portion of the (metal core) printed circuit board.

One or more embodiments of the present invention are related to a backlight assembly that includes a light emitting module, a light guide plate and a receiving container. The light emitting module includes a light source, a printed circuit board (such as a metal core printed circuit board), and a connector part. The (metal core) printed circuit board includes a wiring layer having a wiring electrically connected to the light source, a heat dissipation layer formed under the wiring layer, and a hole (which may be a through hole) passing through the wiring layer and the heat dissipation layer. The connector part is fixed to the hole and electrically connected to the wiring for transmitting a power through the wiring to the light source for driving the light source. The light guide plate includes a light entry surface and a light exiting surface, the light guide plate guiding the light received through the light entry surface to exit through the light exiting surface. The receiving container receives the light emitting module and the light guide plate.

In one or more embodiments, the heat dissipation layer of the (metal core) printed circuit board may contact with the receiving container.

In one or more embodiments, the backlight assembly may further include an inverter disposed under the receiving container electrically connected with the connector part, the inverter and providing the power to the connector part.

According to the present invention, a light source is mounted on a metal core printed circuit board including a heat dissipation layer; therefore, heat generated from the light source may be quickly dissipated to an outside space. In addition, a connector part is inserted in a through hole of a metal core printed circuit board, and thus the connector part may be tightly fixed to the metal core printed circuit board for providing stable and reliable electrical connection. A height of a protrusion of the connector part protruding from an upper surface of the metal core printed circuit board is minimized Advantageously, a dark area caused by the connector part may be minimized, and display quality of a display apparatus according to embodiments of the invention may be optimized.

### BRIEF DESCRIPTION OF THE DRAWINGS

The above and other features and advantages of the present invention will become more apparent by describing in detailed example embodiments thereof with reference to the accompanying drawings, in which:

FIG. 1 is a perspective view illustrating a display apparatus according to one or more embodiments of the present invention;

FIG. 2 is a cross-sectional view taken along a plane indicated by a line IT of FIG. 1;

FIG. 3 is a perspective view illustrating a light emitting module of FIG. 1;

FIG. 4 is an exploded perspective view illustrating the connector part of FIGS. 1 to 3;

FIGS. 5A to 5F are plan views illustrating example embodiments of the adhesive part;

FIG. 6 is an exploded perspective view illustrating a connector part according to one or more embodiments of the present invention;

FIG. 7 is a cross-sectional view taken along a plane indicated by a line II-IF of FIG. 6;

FIG. 8 is a perspective view illustrating a light emitting module according to one or more embodiments of the present invention;

FIG. 9 is a perspective view illustrating a light emitting module according to one or more embodiments of the present invention; and

FIG. 10 is an exploded perspective view illustrating the connector part of FIG. 9.

### DETAILED DESCRIPTION OF THE INVENTION

Hereinafter, the present invention will be explained in detail with reference to the accompanying drawings.

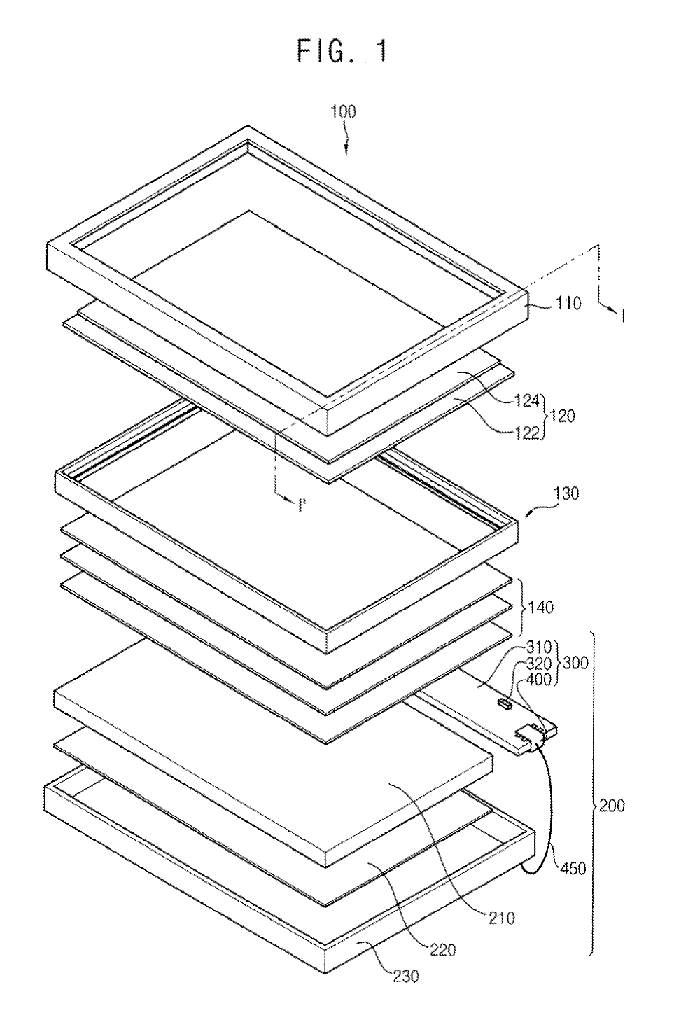

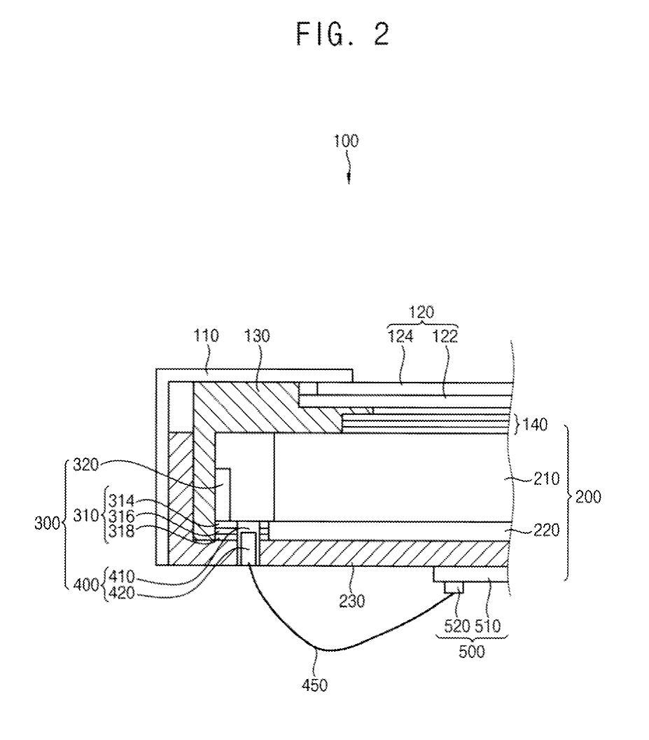

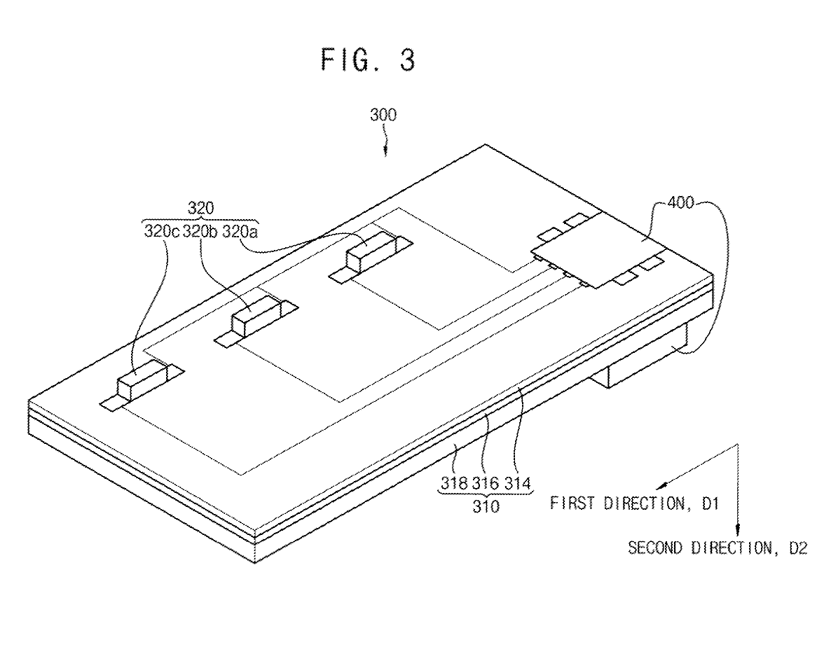

FIG. 1 is a perspective view illustrating a display apparatus according to one or more embodiments of the present invention. FIG. 2 is a cross-sectional view taken along a plane indicated by a line I-I′ of FIG. 1. FIG. 3 is a perspective view illustrating a light emitting module 300 of FIG. 1.

Referring to FIGS. 1 to 3, the display apparatus 100 of the present example embodiment includes a top chassis 110, a display panel 120, and a backlight assembly 200.

The top chassis 110 is disposed over the display panel 120 to protect the display panel 120 from an external impact, and a window is formed through the top chassis 110 to expose a display area of the display panel 120.

The display panel 120 includes a first substrate 122, a second substrate 124 facing the first substrate 122, and a liquid crystal layer (not shown) disposed between the first and second substrates 122 and 124. The display panel 120 displays an image using light exiting from a light exiting surface of a light guide plate 210 of the backlight assembly 200.

The backlight assembly 200 is disposed under the display panel 120 to provide the display panel 120 with the light. The backlight assembly 200 includes the light emitting module 300, the light guide plate 210, a reflection sheet 220, a receiving container 230, and a driving part 500 (illustrated in the example of FIG. 2). The light emitting module 300 includes a metal core printed circuit board 310, a light emitting part 320, and a connector part 400.

The light emitting part 320 includes a first light source 320a, a second light source 320b, and a third light source 320c. For example, each of the light sources 320a, 320b, and 320c may be a light emitting diode (LED). The number of light sources in the light emitting part 320 is not limited to three illustrated by the light sources 320a, 320b, and 320c in FIG. 3, but can be a number other than three. The first to third light sources 320a, 320b and 320c are illustrated in FIG. 3 for convenience of description.

The metal core printed circuit board 310 includes a wiring layer 314, an insulation layer 316 and a heat dissipation layer 318. The light emitting part 320 is mounted on the wiring layer 314. Wirings electrically connected to each of the light sources 320a, 320b, and 320c and transferring a power for driving the light emitting part 320 are formed on the wiring layer 314. For example, the wiring layer 314 may include a copper material. The heat dissipation layer 318 is disposed under the wiring layer 314 and dissipates heat generated from the light emitting part 320 to an outside space external to the metal core printed circuit board 310. For example, the heat dissipation layer 318 may include an aluminum material. The insulation layer 316 electrically insulates the wiring layer 314 and the heat dissipation layer 318 from each other.

A through hole passing through the wiring layer 314, the insulation layer 316, and the heat dissipation layer 318 is formed at the metal core printed circuit board 310, and the connector part 400 is inserted into and/or disposed in the through hole to be fixed to the metal core printed circuit board 310. For example, the through hole may be formed at a portion of an outer portion in the metal core printed circuit board 310, and thus a portion of the connector part 400 may be exposed to an outside.

The connector part 400 is fixed to the through hole formed at the metal core printed circuit board 310 and does not substantially protrude from an upper surface of the metal core printed circuit board 310. The connector part 400 receives the power from the driving part 500 (or a power source) to transmit the power to the wirings formed on the wiring layer 314. A protruded portion of the connector part 400 may protrude from a lower surface of the metal core printed circuit board 310. For example, a height of the protruded portion of the connector part 400 protruding from the lower surface of the metal core printed circuit board 310 may be less than 1 mm, and a thickness of the connector part 400 may be less than 2 mm.

The connector part 400 includes a first connector 410 and a second connector 420. The first connector 410 is inserted into and/or disposed at the through hole of the metal core printed circuit board 310. For example, the first connector 410 may be inserted into the through hole of the metal core printed circuit board 310 in a first direction D1 perpendicular to a second direction D2 which the wiring layer 314, the insulation layer 316, and the heat dissipation layer 318 are laminated and/or superimposed along. In one or more embodiments, the first connector 410 may be inserted into the through hole of the metal core printed circuit board 310 in the second direction D2. The first connector 410 is electrically connected to wirings connected to the light sources 320a, 320b, and 320c. The second connector 420 is inserted into (and/or disposed inside) the first connector 410 and is electrically connected to the first connector 410; the second connector 420 receives the power from the driving part 500 through a wire 450.

The light guide plate 210 includes a light entry surface and a light exiting surface. Incident light generated from the light emitting part 320 of the light emitting module 300 enters the light guide plate 210 through the light entry surface, and the light guide plate 210 guides the light to exit through the light exiting surface and to exit toward the display panel 120.

The reflection sheet 220 is disposed between the light guide plate 210 and the receiving container 230 to reflect light leaked from the light emitting part 320.

The receiving container 230 receives the display panel 120, the light emitting module 300, the light guide plate 210, and the reflection sheet 220.

The driving part 500 includes an inverter 520 providing the power for driving the light sources 320a, 320b, and 320c. The driving part 500 further includes an inverter substrate 510 on which the inverter 520 is mounted. The driving part 500 may be disposed on a rear surface of the receiving container 230, such that the receiving container 230 is disposed between the driving part 500 and the parts received by the receiving container 230, such as the reflection sheet 220.

The display apparatus 100 may further include optical sheets 140 and a mold frame 130. The optical sheets 140 are disposed between the backlight assembly 200 and the display panel 120 to enhance the efficiency of the light emitted from the backlight assembly 200. The optical sheets may include a diffusion sheet, a prism sheet, and a light-condensing sheet.

The mold frame 130 is disposed between the display panel 120 and the optical sheets 140 to support the display panel 120. In addition, the mold frame 130 fixes the light guide plate 210, the optical sheets 140, and the reflection sheet 220 to the receiving container 230. Each of the light guide plate 210, the optical sheets 140, and the reflection sheet 220 is disposed and secured between the receiving container and at least a portion of the mold frame 130.

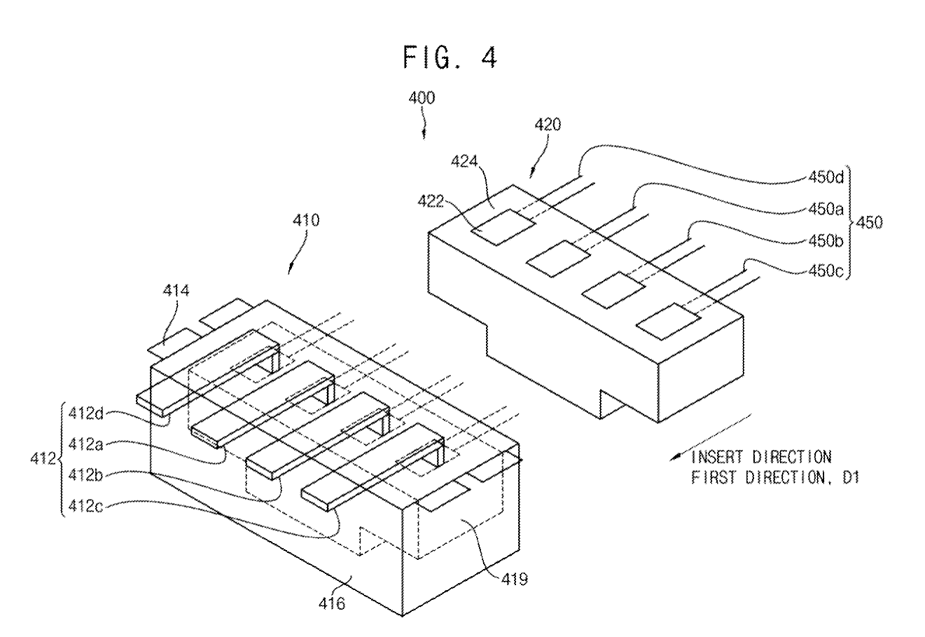

FIG. 4 is an exploded perspective view illustrating the connector part 400 of FIGS. 1 to 3.

Referring to FIGS. 3 and 4, the connector part 400 includes a first connector 410 and a second connector 420 inserted into (and/or disposed inside) a groove 419 formed at the first connector 410. The second connector 420 may be inserted into the first connector 410 in the first direction D1 perpendicular to the second direction D2 which the wiring layer 314, the insulation layer 316, and the heat dissipation layer 318 of the metal core printed circuit board 310 are laminated and/or superimposed along. In one or more embodiments, the wire 450 may be connected to the second connector 420 in the first direction D1.

The first connector 410 includes a conduction part 412, an adhesive part 414, and a first housing 416. The conduction part 412 may be disposed at a top surface of the first housing 416. A first terminal of the conduction part 412 (which may extend in the first direction) is electrically connected to the wiring formed on the metal core printed circuit board 310, and a second terminal of the conduction part 412 (which may extend in the second direction) is electrically connected to the second connector 420. The first housing 416 exposes the first terminal of the conduction part 412 and receives the conduction part 412. In addition, the groove 419, in which the second connector 420 is inserted in the first direction D1, is formed at a side surface of the first housing 416, the side surface of the first housing 416 being adjacent to (and substantially perpendicular to) the top surface of the first housing 416, at which the conduction part is disposed. The groove 419 may include an opening formed at the side surface of the first housing 416 for receiving the second connector 420. The adhesive part 414 is fixed to the first housing 416 and adhered to the wiring layer 314 to prevent the connector part 400 from being separated from the metal core printed circuit board 310. For example, the adhesive part 414 may be adhered to the wiring layer 314 using a soldering method.

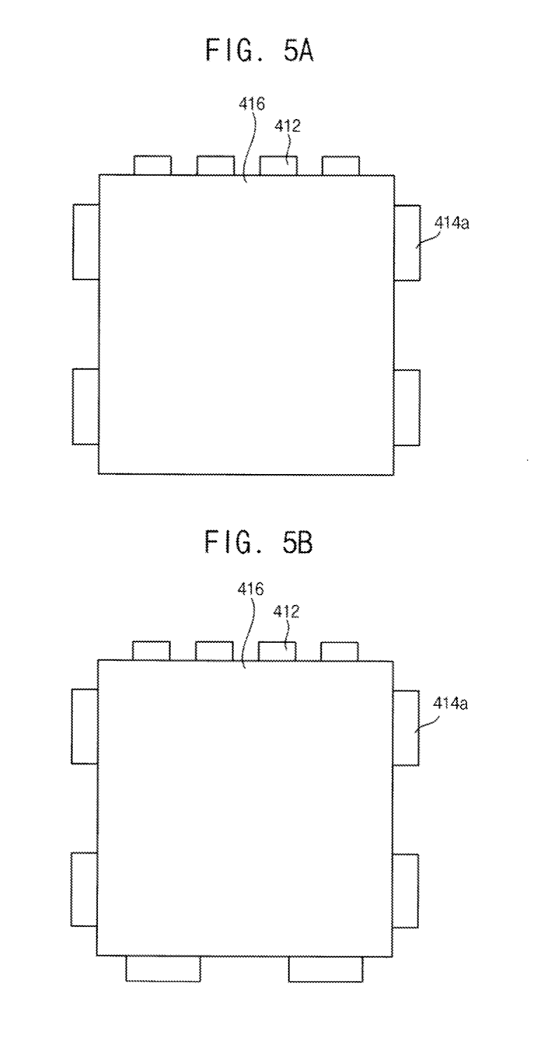

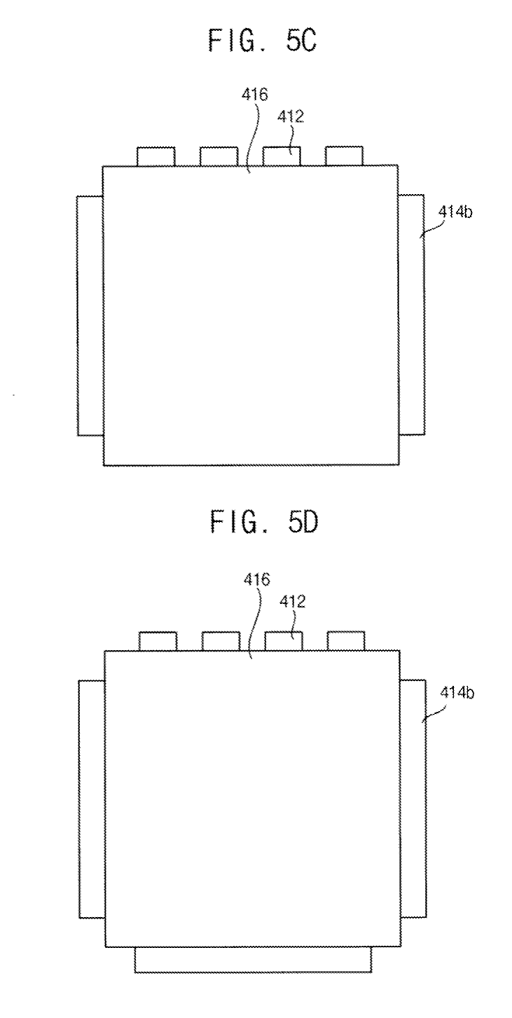

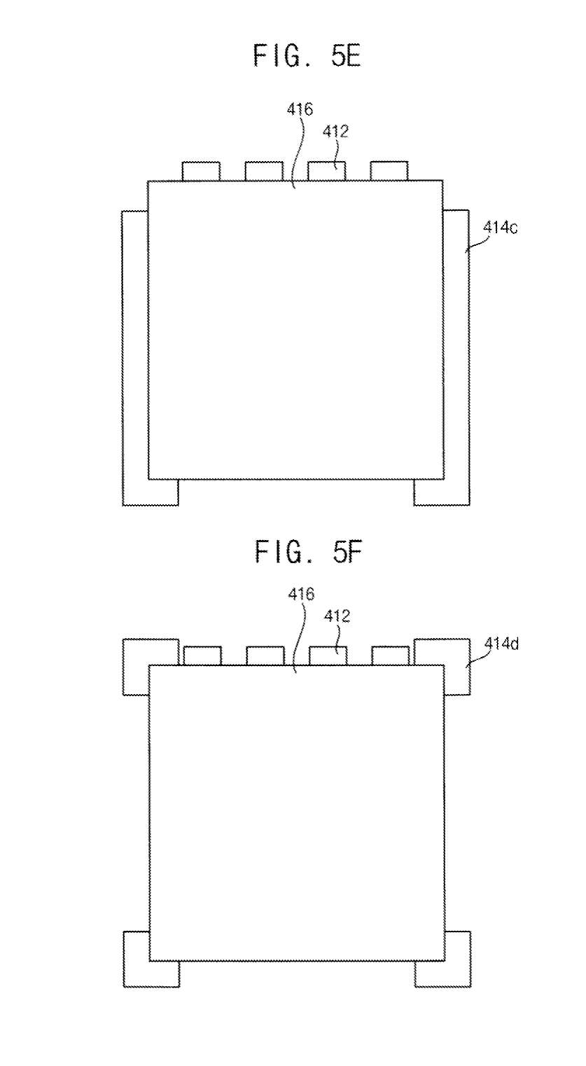

FIGS. 5A to 5F are plan views illustrating example embodiments of the adhesive part 414.

Referring to FIG. 5A, two adhesive parts 414a may be formed at each of both side surfaces adjacent to (and substantially perpendicular to) a first side surface from which the conduction part 412 protrudes in a plan view. In this case, the number of the adhesive part 414a disposed at each of the side surfaces is not limited two. Thus, a plurality of adhesive parts 414a spaced apart from each other may be formed at each of the side surfaces.

Referring to FIG. 5B, two adhesive parts 414a may be formed at three side surfaces except for the first side surface from which the conduction part 412 protrudes in a plan view. A plurality of adhesive parts 414a spaced apart from each other may be formed at each of the three side surfaces.

Referring to FIG. 5C, one adhesive part 414b may be formed at each of the both side surfaces adjacent to (and substantially perpendicular to) the first side surface from which the conduction part 412 protrudes in a plan view. The adhesive part 414b may be formed at the both side surfaces except for each of terminal portions of the both side surfaces. In one or more embodiments, the adhesive part 414b respectively formed at each of the side surfaces may be formed in a single body.

Referring to FIG. 5D, the adhesive parts 414b may be respectively formed at three side surfaces except for the first side surface from which the conduction part 412 protrudes in a plan view. The single adhesive part 414b respectively formed at each of the three side surfaces may be formed in a single body.

Referring to FIG. 5E, an adhesive part 414c may be formed at each of the both side surfaces adjacent to the first side surface from which the conduction part 412 protrudes in a plan view, and each of the adhesive parts 414c may be extended to a second side surface opposite to the first side surface. The adhesive part 414c respectively formed at each of the side surfaces may be formed in a single body.

Referring to FIG. 5F, an adhesive part 414d may be formed at each of the four corners of the first housing 416.

Referring to FIG. 4 again, the second connector 420 includes a terminal part 422, a second housing 424, and the wire 450. The first terminal of the terminal part 422 makes contact with the second terminal of the conduction part 412 (which may extend in the second direction), and the second terminal of the terminal part 422 is electrically connected to the wire 450. The second housing 424 exposes the first terminal of the terminal part 422 and receives the terminal part 422. Therefore, the conduction part 412 of the first connector 410 and the terminal part 422 of the second connector 420 are electrically connected to each other, and thus the conduction part 412 and the wire 450 are electrically connected to each other.

The wire 450 may include a first wire 450a, a second wire 450b, a third wire 450c respectively transmitting a first power to the first light source 320a, the second light source 320b, and the third light source 320c. The wire 450 may also include a fourth wire 450d transmitting a second power to the first light source 320a, the second light source 320b, and the third light source 320c, wherein the second power may have a polarity opposite to a polarity of the first power. In one or more embodiments, the conduction part 412 may include a first conduction part 412a connected between the first light source 320a and the first wire 450a, a second conduction part 412b connected between the second light source 320b and the second wire 450b, a third conduction part 412c connected between the third light source 320c and the third wire 450c, and a fourth conduction part 412d connected between the light sources 320a, 320b, and 320c and the fourth wire 450d. Advantageously, the light sources 320a, 320b, and 320c may be individually turned on/off.

In the example illustrated in FIG. 3, the light emitting part 320 includes three light sources 320a, 320b and 320c; however, the number of light sources is not limited thereto, and the light emitting part 320 may include N (N is an integer) units of light source with N being a number other than three.

In one or more embodiments, the light emitting part 320 is mounted on the metal core printed circuit board 310, which includes the heat dissipation layer 318, the heat dissipation layer 318 making contact with the receiving container 230. Advantageously, heat generated from the light emitting part 320 may be quickly dissipated through the heat dissipation layer 318 and the receiving container 230 to an outside space external to the metal core printed circuit board 310 and/or external to the display apparatus 100.

In one or more embodiments, the connector part 400 is inserted into (and/or disposed in) the through hole of the metal core printed circuit board 310; thus the connector part 400 may be tightly and securely fixed to the metal core printed circuit board 310 for ensuring reliable electrical connection. In addition, the height of any protrusion of the connector part 400 protruding from the upper surface of the metal core printed circuit board 310 may be minimized. Advantageously, the dark area caused by the connector part 400 may be minimized.

In one or more embodiments, the connector part 400 includes the adhesive part 414 adhered to the metal core printed circuit board 310, and thus movement of the connector part 400 relative to the metal core printed circuit board 310 and separation of the connector part 400 from the metal core printed circuit board 310 may be prevented and/or minimized Advantageously, damage to electrical connection components (such as wires, terminals, and conduction parts) may be avoided, and reliable electrical connection may be provided.

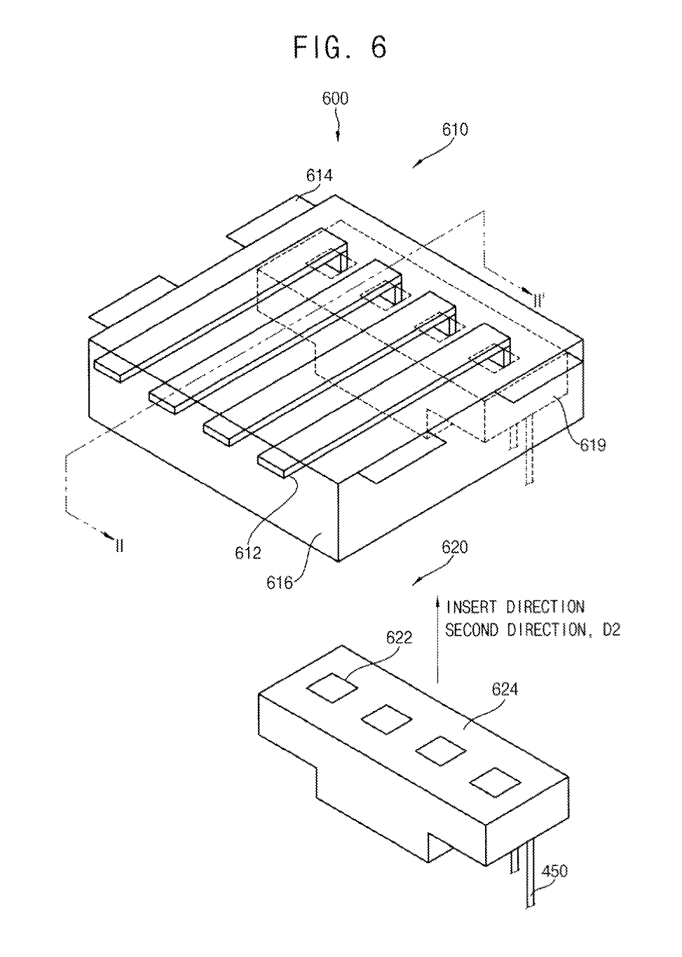

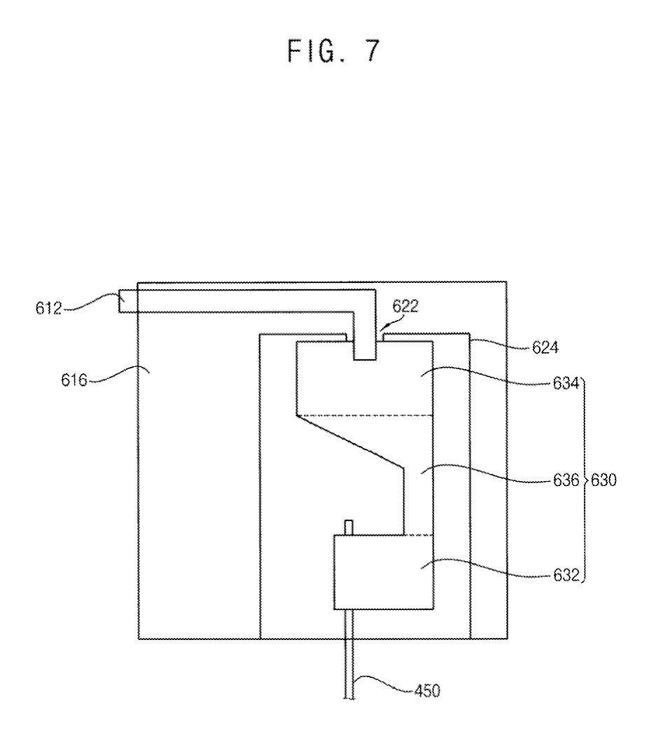

FIG. 6 is an exploded perspective view illustrating a connector part 600 according to one or more embodiments of the present invention. FIG. 7 is a cross-sectional view taken along a plane indicated by a line II-II′ of FIG. 6.

The connector part 600 may be included in a light emitting module of a display apparatus. In one or more embodiments, the light emitting module including the connector part 600 may be substantially the same as or analogous to the light emitting module 300 illustrated in the examples of FIGS. 1 to 3 except for the connector part 600. Thus, the same reference numerals may be used to refer to same or like parts as those described in the previous examples, and repetitive explanation may be omitted.

Referring to FIGS. 6 and 7, the connector part 600 of the present example embodiment includes a first connector 610 and a second connector 620 inserted into (and/or disposed inside) a groove 619 formed at the first connector 610. The second connector 620 may be inserted into the first connector 610 in the second direction D2 which the wiring layer 314, the insulation layer 316, and the heat dissipation layer 318 of the metal core printed circuit board 310 are laminated and/or superimposed along. In one or more embodiments, the wire 450 may be connected to the second connector 620 in the second direction D2.

The first connector 610 includes a conduction part 612, an adhesive part 614, and a first housing 616. The conduction part 612 may be disposed at an upper surface of the first housing 616. The respective conduction part 612 and the adhesive part 614 may be substantially the same as or analogous to the conduction part 412 and the adhesive part 414 illustrated in FIG. 4, and thus repetitive explanation concerning the conduction part 612 and the adhesive part 614 may be omitted. The groove 619, in which the second connector 620 is inserted in the second direction D2, is formed at a lower surface of the first housing 616, the lower surface of the first housing 616 being opposite to the upper surface of the first housing 616, at which the conduction part 612 is disposed. The groove 619 may include an opening formed at the lower surface of the first housing 616 for receiving the second connector 620.

The second connector 620 includes a second housing 624 having an opening hole 622 formed at an upper surface of the second housing 624, and the wire 450 inserted into the second housing 624. In the second housing 624, a receptacle 630 (illustrated in the example of FIG. 7) electrically connecting the conduction part 612 and the wire 450 is formed.

The receptacle 630 includes a first fixing part 632, a second fixing part 634, and a connection part 636. The first fixing part 632 is electrically connected to the wire 450 and fixes/secures the wire 450. The second fixing part 634 includes a fixing groove for fixing/securing the conduction part 612 of the first connector 610 inserted into the fixing groove, and the second fixing part 634 is electrically connected to the conduction part 612. The connection part 636 electrically connects the first fixing part 632 and the second fixing part 634. Thus, the conduction part 612 and the wire 450 are electrically connected to each other.

In one or more embodiments, the second connector 620 is inserted into the first connector 610 in the second direction D2 that is a vertical direction and/or the direction in which the wiring layer 314, the insulation layer 316, and the heat dissipation layer 318 of the metal core printed circuit board 310 are laminated and/or superimposed. In one or more embodiments, the receptacle 630 includes the first fixing part 632 fixing/securing the wire 450 and the second fixing part 634 fixing/securing the conduction part 612. Advantageously, stable and reliable electrical connection between the wire 450 and the conduction part 612 may be provided, and electrical disconnection between the wire 450 and the conduction part 612 may be prevented.

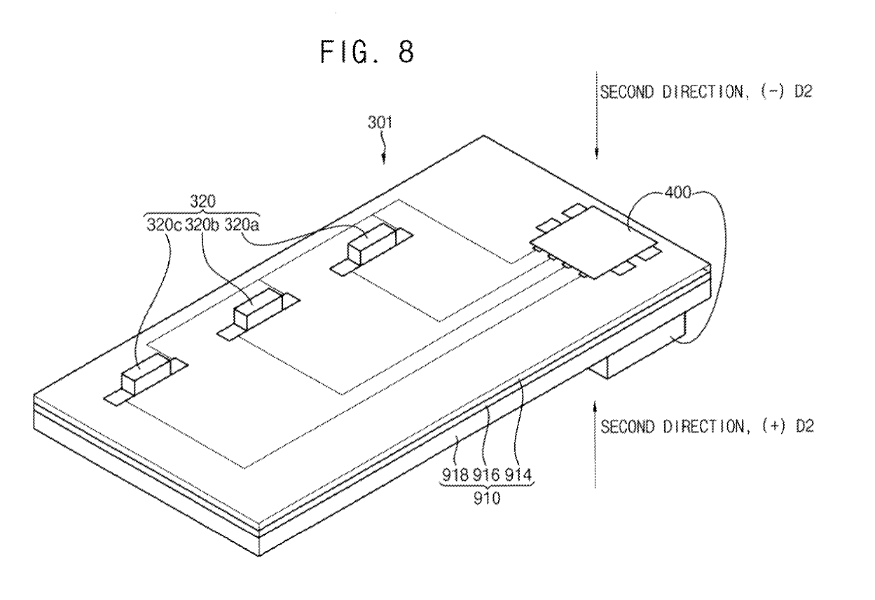

FIG. 8 is a perspective view illustrating a light emitting module 301 according to one or more embodiments of the present invention.

The light emitting module 301 may be included in a display apparatus, and the light emitting module 301 may be substantially the same as or analogous to the light emitting module 300 illustrated in FIGS. 1 to 3 except for a position of the through hole formed at the metal core printed circuit board 310 and a position of the connector part 400. Thus, the same reference numerals may be used to refer to same or like parts as those described in the previous examples, and repetitive explanation may be omitted.

Referring to FIG. 8, the light emitting module 301 includes a metal core printed circuit board 910, the light emitting part 320, and the connector part 400.

The metal core printed circuit board 910 includes a wiring layer 914, an insulation layer 916, and a heat dissipation layer 918. The respective wiring layer 914, the insulation layer 916, and the heat dissipation layer 918 may be substantially the same as or analogous to the wiring layer 314, the insulation layer 316, and the heat dissipation layer 318 illustrated in FIG. 3, and thus repetitive explanation concerning the wiring layer 914, the insulation layer 916, and the heat dissipation layer 918 may be omitted.

A through hole passing through the wiring layer 914, the insulation layer 916, and the heat dissipation layer 918 is formed at the metal core printed circuit board 910, and the connector part 400 electrically connected to the light emitting part 320 is inserted into the through hole. The through hole may be formed at an inner portion of the metal core printed circuit board 910 surrounded by an outer portion of the metal core printed circuit board 910 in a plan view. Thus, a groove is not formed at any of four side surfaces of the metal core printed circuit board 910 (which are adjacent to and substantially perpendicular to the top surface of the metal core printed circuit board 910 at which the light emitting part 320 is disposed), therefore, the four side surfaces of the metal core printed circuit board 910 are continuously extended. The connector part 400 may be formed at the inner portion of the metal core printed circuit board 910 and may be surrounded by the continuously extended side surfaces of the metal core printed circuit board 910.

The connector part 400 includes a first connector 410 and a second connector 420. The first connector 410 is inserted into the through hole of the metal core printed circuit board 910 in a negative second direction −D2, and the second connector 420 is inserted into the through hole of the metal core printed circuit board 910 in a positive second direction +D2.

In one or more embodiments, conduction parts of the connector part 400 connected to the wirings on the metal core printed circuit board 910 may protrude from the connector part 400 in the same direction. In one more embodiments, the conduction parts may protrude from different sides of the connector part 400 in different directions, for example, in two directions opposite to each other, to be connected to the light emitting part 320. In one or more embodiments, the number of conduction parts protruding from a first side of the connector part 400 may be different from the number of conduction parts protruding from a second side of the connector part 400. For example, the number of the conduction parts disposed closer to a side surface of the metal core printed circuit board 910 may be less than the number of the conduction parts disposed closer to a central portion of the metal core printed circuit board 910.

According to the present example embodiment, the connector part 400 is fixed to the inner portion of the metal core printed circuit board 910 and is surrounded by the continuously extended side surfaces (except for the top surface of the metal core printed circuit board 910 on which the light emitting part 320 is mounted and the bottom surface of the metal core printed circuit board 910); four sides of the connector part 400 are attached to four inner surfaces of the metal core printed circuit board 910. Advantageously, the connector part 400 may be tightly fixed to the metal core printed circuit board 910 to provide stable and reliable electrical connection.

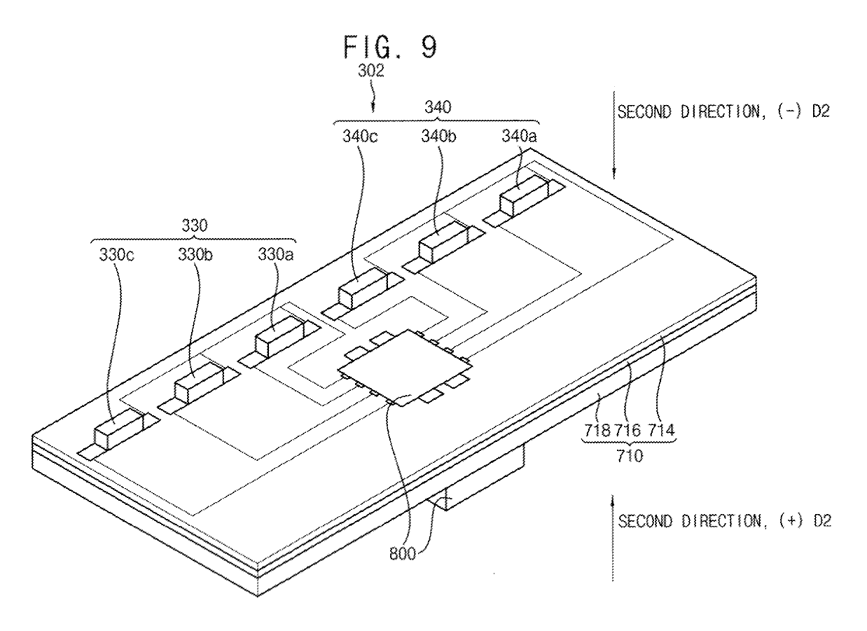

FIG. 9 is a perspective view illustrating a light emitting module 302 according to one or more embodiments of the present invention.

The light emitting module 302 may be included in a display apparatus, and the display apparatus including the light emitting module 302 may be substantially the same as or analogous to the display apparatus 100 according to the previous example embodiment illustrated in FIGS. 1 and 2 except for the light emitting module 300. Thus, the same reference numerals will be used to refer to same or like parts as those described in the previous examples, and repetitive explanation may be omitted.

Referring to FIG. 9, the light emitting module 302 includes a metal core printed circuit board 710, a first light emitting part 330, a second light emitting part 340, and a connector part 800.

The first light emitting part 330 includes a first light source 330a, a second light source 330b, and a third light source 330c. The second light emitting part 340 includes a fourth light source 340a, a fifth light source 340b, and a sixth light source 340c. The first light emitting part 330 and the second light emitting part 340 are mounted on the metal core printed circuit board 710.

The metal core printed circuit board 710 includes a wiring layer 714, an insulation layer 716, and a heat dissipation layer 718. The respective wiring layer 714, the insulation layer 716, and the heat dissipation layer 718 may be substantially the same as or analogous to the wiring layer 314, the insulation layer 316, and the heat dissipation layer 318 illustrated in FIG. 3, and thus repetitive explanation concerning the wiring layer 714, the insulation layer 716, and the heat dissipation layer 718 may be omitted.

A through hole passing through the wiring layer 714, the insulation layer 716, and the heat dissipation layer 718 is formed at an inner portion or a central portion of the metal core printed circuit board 710, and the connector part 800 electrically connected to the first light emitting part 330 and the second light emitting part 340 through the wiring on the metal core printed circuit board 710 is inserted into and/or disposed at the through hole.

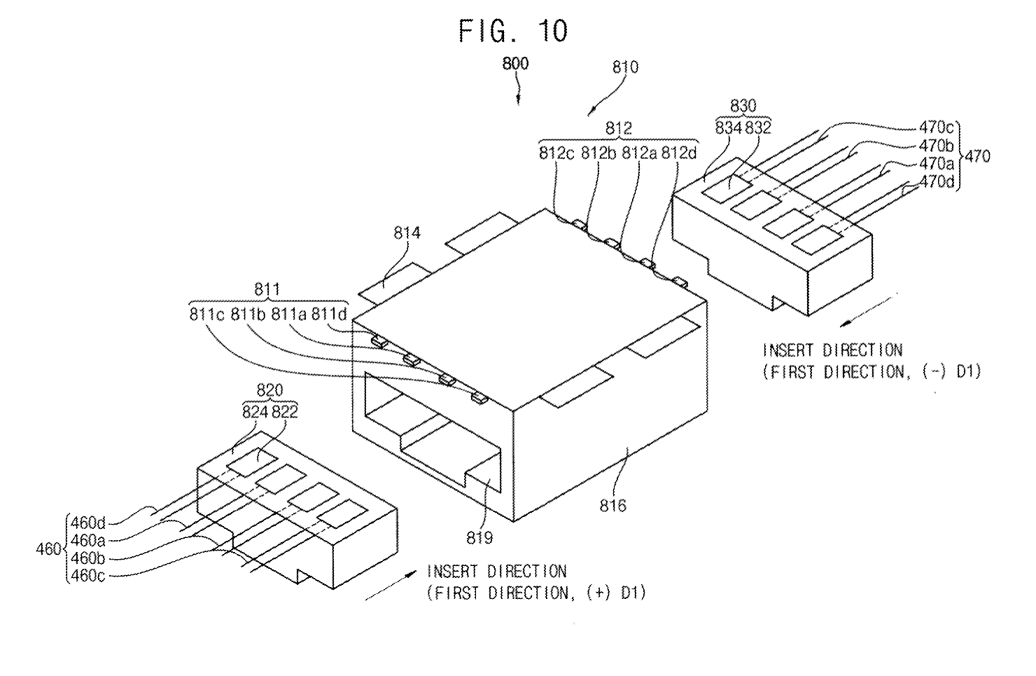

FIG. 10 is an exploded perspective view illustrating the connector part 800 of FIG. 9.

Referring to FIGS. 9 and 10, the connector part 800 includes a first connector 810, a second connector 820, and a third connector 830.

The first connector 810 includes a first group conduction part 811, a second group conduction part 812, an adhesive part 814, and a first housing 816. The first group conduction part 811 is electrically connected to the first light emitting part 330, and the second group conduction part 812 is electrically connected to the second light emitting part 340. The adhesive part 814 is fixed to the first housing 816 and is adhered to the wiring layer 714, and thus the connector part 800 may be secured in the metal core printed circuit board 710 for providing stable and reliable electrical connection. The first housing 816 includes a hole 819, in which the second connector 820 and the third connector 830 are inserted through a first side surface of the first housing 816 and a second side surface of the first housing 816 opposite to the first side surface of the first housing 816 in a positive first direction and a negative first direction +D1 and −D1, respectively. The hole 819 may include a first opening formed at the first side surface of the first housing 816 and a second opening formed at the second side surface of the first housing 816, the first opening being configured for receiving the second connector 820, the second opening being configured for receiving the third connector 830. In one or more embodiments, the first housing 816 may include two separate grooves formed at the first side surface of the first housing 816 and the second side surface of the first housing 816, respectively, and the second connector 820 and the third connector 830 may be respectively inserted into the two separate grooves.

The second connector 820 includes a terminal part 822, a second housing 824, and a first group wire 460. The respective terminal part 822 and the second housing 824 are substantially the same as or analogous to the terminal part 422 and second housing 424 illustrated in FIG. 4, and a connection between the first group conduction part 811 and the terminal part 822 is substantially the same as or analogous to the connection between the conduction part 412 and the terminal part 422 illustrated in FIG. 4. Thus, repetitive explanation concerning the terminal part 822, the second housing 824, and the connection between the first group conduction part 811 and the terminal part 822 may be omitted.

The first group wire 460 may include a first wire 460a, a second wire 460b, a third wire 460c respectively transmitting a first power to the first light source 330a, the second light source 330b, and the third light source 330c. The first group wire 460 may also include a fourth wire 460d transmitting a second power to the first light source 330a, the second light source 330b, and the third light source 330c, wherein the second power may have a polarity opposite to a polarity of the first power. In one or more embodiments, the first group conduction part 811 includes a first conduction part 811a connected between the first light source 330a and the first wire 460a, a second conduction part 811b connected between the second light source 330b and the second wire 460b, a third conduction part 811c connected between the third light source 330c and the third wire 460c, and a fourth conduction part 811d connected between the first, second, and third light sources 330a, 330b, and 330c and the fourth wire 460d.

The third connector 830 includes a terminal part 832, a third housing 834, and a second group wire 470. The respective terminal part 832 and the third housing 834 are substantially the same as or analogous to the terminal part 422 and the second housing 424 illustrated in FIG. 4, and a connection between the second group conduction part 812 and the terminal part 832 is substantially the same as or analogous to the connection between the conduction part 412 and the terminal part 422 illustrated in FIG. 4. Thus, repetitive explanation concerning the terminal part 832, the third housing 834, and the connection between the second group conduction part 812 and the terminal part 832 may be omitted.

The second group wire 470 includes a fifth wire 470a, a sixth wire 470b, and a seventh wire 470c respectively transmitting the first power to the fourth light source 340a, the fifth light source 340b, and the sixth light source 330c. The second group wire 470 may also include an eighth wire 470d transmitting the second power having the polarity opposite to the polarity of the first power to the fourth, fifth, and sixth light sources 340a, 340b, and 340c. In one or more embodiments, the second group conduction part 812 includes a fifth conduction part 812a connected between the fourth light source 340a and the fifth wire 470a, a sixth conduction part 812b connected between the fifth light source 340b and the sixth wire 470b, a seventh conduction part 812c connected between the sixth light source 330c and the seventh wire 470c, and an eighth conduction part 812d connected between the fourth, fifth, and sixth light sources 340a, 340b, and 340c and the eighth wire 470d.

In one or more embodiments, the number of the conduction part in the first group conduction part 811 and the number of the conduction part in the second group conduction part 812 are the same. In one or more embodiments, the number of the conduction part in the first group conduction part 811 and the number of the conduction part in the second group conduction part 812 may be different from each other. In one or more embodiments, the number of the conduction parts disposed closer to a side surface of the metal core printed circuit board 710 is less than the number of the conduction parts disposed closer to the central portion of the metal core printed circuit board 710.

In the example of FIG. 9, each of the first light emitting part 330 and the second light emitting part 340 includes three light sources. In one or more embodiments, each of the first light emitting part 330 and the second light emitting part 340 may includes N (N is an integer) units of light source with N being other than three.

In one or more embodiments, the light emitting module 302 includes the second connector 820 transmitting power to the first, second, and third light sources 330a, 330b, and 330c; the light emitting module 302 also includes the third connector 830 transmitting power to the fourth, fifth, and sixth light sources 340a, 340b, and 340c. Advantageously, the first to sixth light sources 330a, 330b, 330c, 340a, 340b, and 340c may be turned on/off individually and/or as a group.

According to one or more embodiments of the present invention, in the light emitting module and the backlight assembly having the light emitting module, a light source is mounted on a metal core printed circuit board including a heat dissipation layer. Advantageously, heat generated from the light source may be quickly dissipated to an outside space external to the display apparatus, and thus expansion or deformation of a light guide plate caused by heat may be prevented.

In one or more embodiments, a connector part is inserted into a through hole of a metal core printed circuit board, and thus the connector part may be tightly fixed to the metal core printed circuit board for providing stable and reliable electrical connection. A height of a protrusion of the connector part protruding from an upper surface of the metal core printed circuit board may be minimized Advantageously, a dark area caused by the connector part may be minimized, and a display quality of a display apparatus may be optimized.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A light emitting module comprising:
a light source;
a printed circuit board including a wiring layer having a wiring electrically connected to the light source, a heat dissipation layer formed under the wiring layer, and a through hole passing through the wiring layer and the heat dissipation layer; and
a connector part disposed in the through hole and electrically connected to the wiring for transmitting a power through the wiring to the light source.

2. The light emitting module of claim 1, wherein the connector part comprises:
a first connector disposed in the through hole electrically connected to the wiring layer; and
a second connector fixed to the first connector, electrically connected to the first connector, and receiving the power from a power source.

3. The light emitting module of claim 2, wherein the first connector comprises:
a conduction part electrically connected to the wiring; and
a first housing carrying the conduction part and exposing a first terminal of the conduction part, the second connector being disposed inside the first housing.

4. The light emitting module of claim 3, wherein the second connector comprises:
a wire receiving the power;
a terminal part electrically connecting the wire and the conduction part; and
a second housing carrying the terminal part and exposing a first terminal of the terminal part, the first terminal of the terminal part contacting with a second terminal of the conduction part.

5. The light emitting module of claim 3, wherein the second connector comprises:
a second housing;
a wire receiving the power; and
a receptacle disposed inside the second housing and electrically connecting the wire and the conduction part.

6. The light emitting module of claim 5, wherein t the second housing includes an opening hole, and a portion of the conduction part is disposed through the opening hole.

7. The light emitting module of claim 5, wherein the receptacle comprises:
a first fixing part receiving and securing the wire;
a second fixing part receiving and securing the conduction part; and
a connection part electrically connecting the first fixing part and the second fixing part.

8. The light emitting module of claim 3, wherein the first connector further includes an adhesive part adhered to the printed circuit board.

9. The light emitting module of claim 8, wherein the conduction part protrudes beyond a first side surface of the first housing, the adhesive part is formed at a second side surface of the first housing and a third side surface of the first housing, and the second side surface of the first housing and the third side surface of the first housing are adjacent to the first side surface of the first housing.

10. The light emitting module of claim 9, wherein the adhesive part is further formed at a fourth side surface of the first housing opposite to the first side surface of the first housing.

11. The light emitting module of claim 8, wherein the adhesive part is formed at four corners of the first housing.

12. The light emitting module of claim 2, wherein the first connector includes a groove receiving the second connector.

13. The light emitting module of claim 12, wherein the first connector includes a conduction part electrically connected to the wiring, the conduction part is disposed at a first side of the first connector, the groove includes a first opening for receiving the second connector, the first opening is disposed at a second side of the first connector, and the second side of the first connector is perpendicular to the first side of the first connector.

14. The light emitting module of claim 13, wherein the connector part further comprises a third connector, the groove further includes a second opening for receiving the third connector, the second opening is disposed at a third side of the first connector, and the third side of the first connector is opposite to the second side of the first connector.

15. The light emitting module of claim 12, wherein the first connector includes a conduction part electrically connected to the wiring, the conduction part is disposed at a first side of the first connector, the groove includes an opening for receiving the second connector, the opening is disposed at a second side of the first connector, and the second side of the first connector is opposite to the first side of the first connector.

16. The light emitting module of claim 1, wherein the through hole is formed at an edge portion of the printed circuit board, the connector part includes a conduction part electrically connected to the wiring, the conduction part is disposed at a first side of the connector part, a second side of the connector part is perpendicular to the first side of the connector part, and the second side of the connector part is exposed from the printed circuit board at the edge of the printed circuit board.

17. The light emitting module of claim 1, wherein the through hole is formed at an inner portion of the printed circuit board, and the connector part is surrounded by an outer portion of the printed circuit board.

18. A backlight assembly comprising:
a light emitting module comprising:
a light source;
a printed circuit board including a wiring layer having a wiring electrically connected to the light source, a heat dissipation layer formed under the wiring layer, and a hole passing through the wiring layer and the heat dissipation layer; and
a connector part fixed to the hole and electrically connected to the wiring for transmitting a power through the wiring to the light source;
a light guide plate including a light entry surface and a light exiting surface, the light guide plate guiding a light received through the light entry surface to exit through the light exiting surface; and
a receiving container receiving the light emitting module and the light guide plate.

19. The backlight assembly of claim 18, wherein the heat dissipation layer of the printed circuit board contacts with the receiving container.

20. The backlight assembly of claim 19, further comprising:
an inverter disposed under the receiving container and electrically connected with the connector part, the inverter providing the power to the connector part.
